(19) United States
(12) Patent Application Publication
(10) Pub. No.: US 2005/0110918 A1
(43) Pub. Date: May 26, 2005

(54) Display unit and gaming machine

(75) Inventor: Takashi Izawa, Tokyo (JP)

Correspondence Address: LEYDIG VOIT & MAYER, LTD, 700 THIRTEENTH ST. NW, SUITE 300, WASHINGTON, DC, 20005-3960, US

(73) Assignee: Aruze Corp., Tokyo (JP)

(21) Appl. No.: 10/992,121

(22) Filed: Nov. 19, 2004

(30) Foreign Application Priority Data
Nov. 20, 2003 (JP) P2003-391306

(51) Int. Cl. G02F 1/1333

(52) U.S. Cl. 349/58

(57) ABSTRACT

A gaming machine in accordance with an embodiment of the present invention comprises: a cabinet 10 in which an apparatus needed for a game is contained; a liquid crystal panel unit 30 having a liquid crystal panel which an image associated with the game is displayed on, and whose viewing angle is different between one side U and the other side D on a display screen; and a attaching member 40 which has a driver for driving the liquid crystal panel, and which the liquid crystal panel unit is fitted to the cabinet 10 through, wherein engaging portions 46A and 46B to detachably engage with the cabinet 10 and fixable portions 43A and 43B (45A and 45B) to be fixed to the cabinet are provided on both of the side U and the other side D of the attaching member 40.

### CROSS-REFERENCE TO RELATED APPLICATION

This application is based upon and claims the benefit of priority from the prior Japanese Patent Applications No. 2003-391306, filed on Nov. 20, 2003; the entire contents of which are incorporated herein by reference.

### BACKGROUND OF THE INVENTION

1. Field of the Invention

The present invention relates to a display unit and a gaming machine.

2. Related Background of the Invention

Generally, various types of gaming machines are known concerning a mode of a game and a cabinet incorporating a gaming device implementing such a game. For example, slot machines which are known as a kind of gaming machines include a type on which a player plays a game while sitting (a so-called slant-type) as disclosed in Patent Document 1: Japanese Patent Application Laid-open No. 2003-67810, and a type on which a player plays a game while standing (a so-called upright-type) as disclosed in Patent Document 2: Japanese Patent Application Laid-open No. 2001-198265.

Such a slot machine generally comprises a gaming device including a reel unit composed of a plurality of rotation reels arranged side by side in a line to be rotatable on each of which symbols are drawn; and a cabinet incorporating the gaming device therein. Further, the cabinet is provided with a display section allowing the rotation reels to be viewed, and an operation section arranged on the lower front side (the player's side) of the display section and having various operation buttons required for playing games and a coin slot.

### SUMMARY OF THE INVENTION

Incidentally, among slot machines of the foregoing types, there has been a type of slot machine which includes the display section (hereinafter referred to as a “main display section”) through which the rotation reels can be viewed, and which additionally includes a secondary display section provided above the main display section, the secondary display section through which a second game (what is called a second game) is played, for example, under a predetermined condition subsequent to a game played in the main display section. Furthermore, in the slot machine of this type, the secondary display section is detachably attached to the cabinet as a liquid crystal display device. Accordingly, in this case, it is conceivable that the secondary display section (liquid crystal display device) is shared between the slant-type slot machine and the upright-type slot machine which have similar internal structures. In addition, this secondary display section also has a purpose of providing an effect to an audience who is watching the game from the back of the player.

As shown in FIG. 9, the secondary display section 110 normally comprises: a liquid crystal panel unit 100 having a liquid crystal panel for displaying an image associated with a game; and a frame 104 with which the liquid crystal panel unit 100 is attached to a cabinet 102. An IC drive for driving the liquid crystal panel constituting the liquid crystal panel unit 100 is mounted on the frame 104. On the other hand, a wiring cable to be electrically connected to the IC drive extends out from the liquid crystal panel. The liquid crystal panel is electrically connected to the IC drive, and the liquid crystal panel unit 100 is mechanically jointed to the frame 104. When this frame 104 is fitted to the cabinet 102, first, a pair of shafts 106 provided on one side of the frame 104 are hooked up on corresponding hook portions 108 of the cabinet 102 in a setting area S for the secondary display section 100 in the cabinet 102. Thereby, the frame 104 is suspended from the cabinet 102. Thereafter, holes 107 of brackets 109 provided on the other side of the frame 104 are matched respectively with corresponding screw holes 105 provided on the cabinet 102 side. In this state, screws are screwed up into the holes 105 and the corresponding holes 107, thereby firmly fixing the frame 104 onto the cabinet 102.

As described above, the shafts 106 to detachably engage with the cabinet 102 are provided only on one side (the upper side), and the brackets 109 to be fixed onto the cabinet 102 are provided only on the other side (the lower side). This causes the following problem concerning that the secondary display section 110 is shared between the slant-type slot machine and the upright-type slot machine, in conjunction with a characteristic of the viewing angle of the liquid crystal panel.

More specifically, the liquid crystal panel mounted on the slot machine generally has the viewing angle on the upper side different from that on the lower side. In the upright-type slot machine, the liquid crystal panel is mounted in such an orientation that the viewing angle on the lower side is wider because the viewpoints of the player and the audience are located at positions where the player and the audience look up the secondary display section 110. On the other hand, in the slant-type slot machine, the liquid crystal panel is mounted in such an orientation that the viewing angle on the upper side is wider because the viewpoints of the player and the audience are located at positions where the player and the audience look down the secondary display section 110 or positions in front of the secondary display section 110. Therefore, when the secondary display section 110 is intended to be shared between the slant-type slot machine and the upright-type slot machine, the liquid crystal panel (the liquid crystal panel unit 100) needs to be mounted with the upper and lower portions thereof interchanged (rotated 180°) so that the viewing angles on the upper and lower sides are inverted (in this case, the screen display is vertically and horizontally inverted).

Further, when the liquid crystal panel (the liquid crystal panel unit 100) is mounted with the upper and lower portions thereof interchanged, the frame 104 having thereon the IC drive 152 for driving the liquid crystal panel and so on also needs to be mounted with the upper and lower portions thereof interchanged in accordance therewith. This is for consistency in mechanical and electrical positional relation between the IC drive and so on electrically connected to the liquid crystal panel and the liquid crystal panel. This is also because the wiring cable becomes deficient in length unless the upper and lower portions of the frame 104 are interchanged accompanying the interchange of the upper and lower portions of the liquid crystal panel, possibly causing a physical restraint such as impossibility of connection between the IC drive and so on to the liquid crystal panel.

If, however, the frame 104 is arranged with the upper and lower portions thereof interchanged in this manner, the positional relations between the shafts 106 and the brackets 109 on the frame 104 are also reversed. Accordingly, the positions of the respective shafts 106 on the frame 104 do not match the positions of the respective hook portions 108 on the cabinet 102, and the position of the respective holes 107 of the brackets 109 on the frame 104 do not match the position of the respective screw holes 105 on the cabinet 102. In other words, the frame 104 is neither able to be hooked up on the cabinet 102 nor accordingly able to be fixed to the cabinet 102. As a result, this means that the frame 104 cannot be shared between the slant-type slot machine and the upright-type slot machine. Consequently, there has been heretofore no way but some of the frames 104 are exclusively for the slant-type slot machine and the others of the frames 104 are exclusively for the upright-type slot machine. However, from a viewpoint of reducing relevant costs, all of the secondary display sections 110 have been awaited that can be shared between the slant-type slot machine and the upright-type slot machine.

The present invention has developed focusing on the above-described situation, and its object is to provide a gaming machine in which all parts of a liquid crystal display device including a liquid crystal panel having different viewing angles on one side and on the other side can be shared between different types of machines having different player's viewpoint positions on the liquid crystal screen which are on one side or on the other side. In other words, the object of the present invention is to provide a display unit having a liquid crystal panel capable of being shared between gaming machines having different viewpoint positions of the player and audience, and a gaming machine including the display unit.

The display unit of the present invention comprises a liquid crystal display device having a liquid crystal panel unit including a liquid crystal panel and a supporting member for supporting the liquid crystal panel unit; and a housing for providing a setting area to which the liquid crystal display device is set, wherein a center axis of a viewing angle in the liquid crystal panel unit is not parallel to a normal line of a surface of the liquid crystal panel, the housing has a suspending portion from which the liquid crystal display device is suspended and a fixing portion which is provided below the suspending portion, and which fixes the liquid crystal display device to the housing, and the supporting member has a suspendable portion which is hooked up on the suspending portion and a fixable portion which is fixed to the fixing portion on one side and the other side with respect to a center of the supporting member in the direction respectively.

This display unit has the suspendable portion and the fixable portion on each of the two sides respectively. For this reason, the liquid crystal display device can be inverted in order to provide a wider viewing angle in a position where a viewpoint from which the liquid crystal panel is viewed. In other words, depending upon a position in which the display unit is provided, the liquid crystal display device can be inverted. In addition, it is preferable that the suspendable portion and the fixable portion are provided on each of the two sides in a manner symmetrical around the center of the supporting member.

In the display unit of the present invention, the supporting member may be a rectangle-shaped frame, and the suspending portion may be a hook. The fixing portion may include a fastening screw and a screw hole to which the fastening screw is screwed up. The suspendable portion may include shaft holes, which are formed on the one side and the other side respectively in a side surface of the frame, and shafts which are detachably fitted into the shaft holes respectively. The fixable portion may be a bracket including a hole through which a body of the fastening screw is passed.

In addition, the gaming machine of the present invention comprises the display unit of the aforementioned present invention. According to this gaming machine, the direction of the liquid crystal panel can be set in order to provide a wider viewing angle in a position where a viewpoint from which the liquid crystal panel is viewed.

In order to solve the aforementioned problems, the gaming machine of the present invention comprises: a cabinet in which an apparatus needed for a game is contained; a liquid crystal panel unit having a liquid crystal panel for displaying an image associated with the game, the liquid crystal panel having different viewing angles on one side and on the other side on a display screen thereof; and an attaching member which has a driver for driving the liquid crystal panel, and through which the liquid crystal panel unit is attached to the cabinet, wherein the attaching member has engaging means which detachably engages with the cabinet and fixable means which is fixed to the cabinet on both of the one side and the other side thereof.

In this gaming machine, the engaging means which detachably engages with the cabinet and the fixable means which is fixed to the cabinet are not provided on the two sides of the attaching member separately. The engaging means and the fixable means are provided on both sides of the attaching member respectively (i.e. to both of the one side and the other side). Accordingly, even when an engageable portions on the cabinet side for engaging with the engaging means and the fixing portion on the cabinet side to which the fixable means is fixed are provided on the two side of a liquid crystal panel setting area in the cabinet separately (in a case shown by FIG. 9), the engaging means on one of the two sides of the attaching member always matches the position of the engageable portion on the cabinet side, and the fixable means on the side opposite to the engaging means always matches the position of the fixing portion on the cabinet side. This is realized both in a first state that the attaching member is attached to the cabinet and in a second state that the attaching member is inverted around the center of the attaching member by 180 degrees from the first state. For this reason, even if, for example, the liquid crystal panel unit is put upside down by inverting the liquid crystal panel unit by 180 degrees and accordingly the attaching member is inverted by the 180 degrees in order to enable the liquid crystal panel unit to be shared between the slant-type and upright-type slot machines for which a viewpoint of the player is different between the upper and lower sides, the engaging means on one of the two sides of the attaching member can be engaged with the engageable portion in the cabinet, thus enabling the fixable means on the side opposite to the engaging means to be fixed to the fixing portion in the cabinet. Consequently, the attaching member can be shared between the slant-type slot machine and the upright-type slot machine. As a result, the whole of the liquid crystal display device configured of the attaching member and the liquid crystal panel unit can be shared between the slant-type slot machine and the upright-type slot machine. It is a matter of course that this kind of common use is not limited to the slot machine, and that this kind of common use can be realized among various gaming machines for which a viewpoint of the player on the liquid crystal screen is different between one side and the other side.

Additionally, with regard to the aforementioned configuration, the attaching member may be formed as a rectangle-shaped frame; the engaging means may be formed on a side surface of the frame, and may include a shaft hole into which a shaft to be hooked up on the cabinet is detachably fitted; the fixable means may include a bracket formed in the frame and a screw insertion hole, formed in the bracket, through which a screw for fixing the frame to the cabinet passes; and a pair of the shaft hole and the bracket may be provided on both of the two sides of the frame.

It should be noted that the configurations of the engaging means, the fixable means, the suspendable portion and the fixable portion are not limited to the aforementioned configurations, and can take on various configurations. For example, the engaging means and the suspendable portion may be hooks which can be hooked up on the shafts provided on the side of the cabinet or the housing. In addition, the engaging means and the suspendable portion may be configured in a state that the shafts have been fitted in advance into all of the shaft holes respectively, or in a state that the shafts have been fitted in advance into only the shaft holes fitted to the cabinet or the housing. In other words, the engaging means and the suspendable portion may be configured of the shaft holes and the shafts. In this case, the shafts may be provided in the shaft holes in a way that the shafts cannot be detached from the shaft holes. It is a matter of course that the engaging means and the suspendable portion may be configured only of the shafts without the shaft holes (in other words, the shafts as the engaging means and the suspendable portion may be provided on the side surfaces of the attaching member in a protruding manner). Additionally, a magnet, adhesive tape, a latch and welding can be listed as the fixable means.

Furthermore, in the aforementioned configuration, it is preferable that the attaching member has a configuration substantially symmetrical around the central line passing the center of the attaching member. If the attaching member has a configuration substantially symmetrical in this manner, the setting area and the liquid crystal display device do not interfere with each other (the liquid crystal display device can not be set into the setting area) when the liquid crystal display device is inverted by 180 degrees, in a case where, for example, the liquid crystal display device configured of the attaching member and the liquid crystal panel unit is shared between the slant-type slot machine and the upright-type slot machine, and in a case where the setting area of the liquid crystal display device in the slant-type slot machine has the same shape as the setting area of the liquid crystal display device in the upright-type slot machine does.

### BRIEF DESCRIPTION OF THE DRAWINGS

FIG. 1 is a perspective view of an upright-type slot machine according to an embodiment of the present invention.

FIG. 2 is an exploded perspective view of a secondary display section in the slot machine of FIG. 1.

FIG. 3 is a perspective view of an attaching member constituting the secondary display section when viewed from the front.

FIG. 4 is a rear view of the attaching member constituting the secondary display section when viewed from the back.

FIG. 5 is a perspective view of the secondary display section configured by fitting a liquid crystal panel unit to the attaching member when viewed from the front.

FIG. 6 is a perspective view of the secondary display section configured by fitting the liquid crystal panel unit to the attaching member when viewed from the back.

FIG. 7 is an enlarged perspective view of a main part of the secondary display section showing how the secondary display section is fitted to the upright-type slot machine of FIG. 1.

FIG. 8 is a perspective view of a slant-type slot machine to which the secondary display section of FIGS. 5 and 6 can be fitted.

FIG. 9 is an enlarged perspective view of the main part of a conventional secondary display section showing how the conventional secondary display section is fitted to the upright-type slot machine.

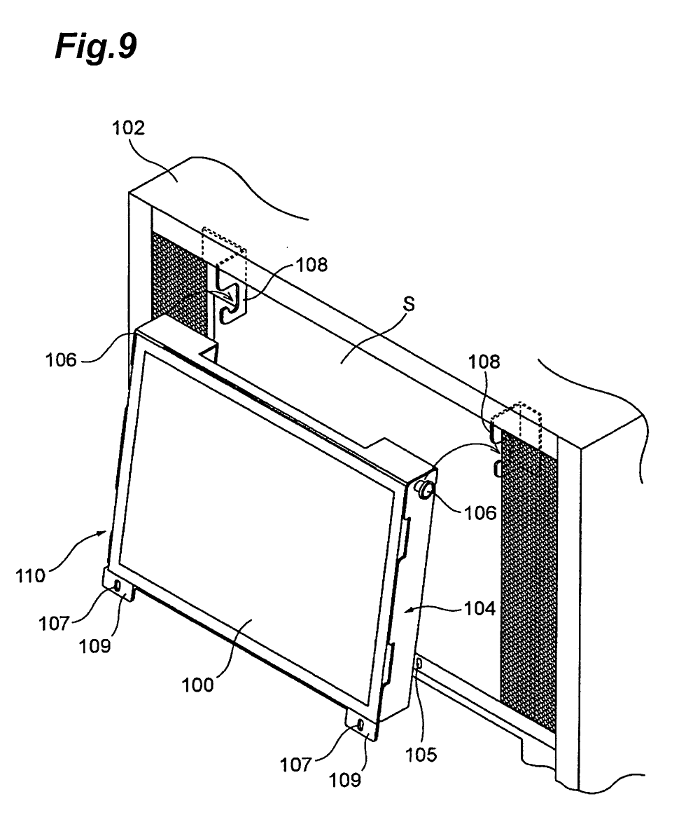

FIG. 10 is a side view schematically showing a liquid crystal panel.

FIG. 11 is a schematic side view showing the secondary display section in a cross-sectioning manner.

FIG. 12 is a side view schematically showing the slot machine of FIG. 1.

FIG. 13 is a side view schematically showing a slant-type slot machine according to another embodiment of the present invention.

### DESCRIPTION OF THE PREFERRED EMBODIMENTS

Concrete descriptions will be provided below for embodiments of the present invention with reference to the drawings.

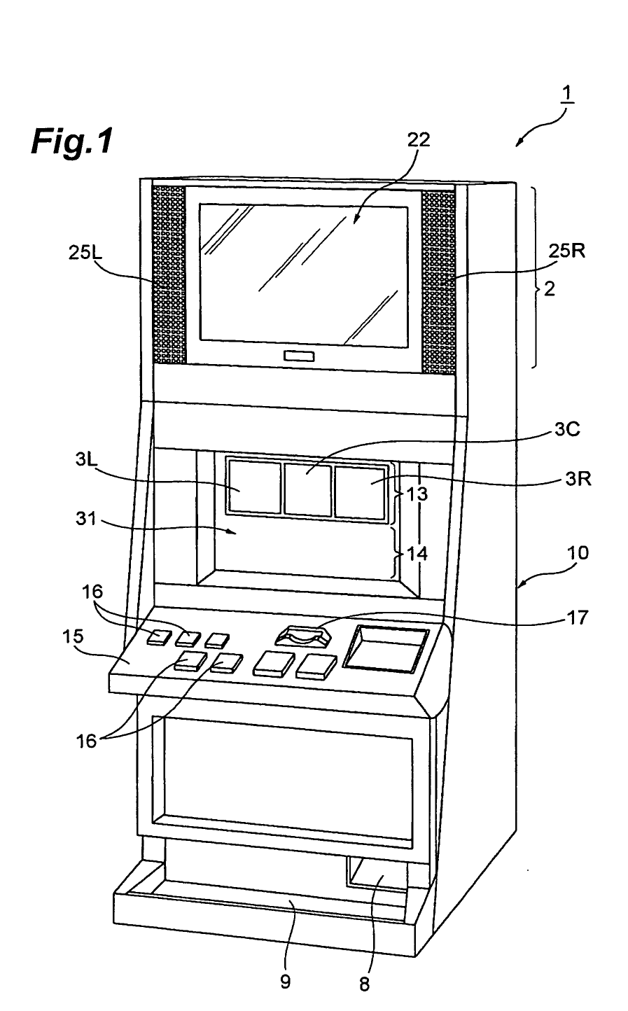

FIG. 1 shows an upright-type slot machine as a gaming machine according to an embodiment of the present invention. As shown in the figure, the slot machine 1 according to the present embodiment comprises; a gaming apparatus including a reel unit configured by rotatably aligning a plurality of rotation reels 3L, 3C and 3R in a horizontal line, on each of the plurality of rotary reels 3L, 3C and 3R symbols (identification information) are drawn; and a cabinet 10, inside which this gaming apparatus is fitted.

The cabinet 10 comprises a main display section 31 which is configured of a liquid crystal display device through which the rotary reels 3L, 3C and 3R can be viewed. Provided on the display screen of the main display section 31A is a symbol display region 13 where symbols on the reels 3L, 3C and 3R are transmission-displayed and a effect display region 14 for displaying a effect image, information and the like.

In addition, the cabinet 10 comprises a pedestal portion (operation part) 15 having a gradually inclined surface beneath the front position of the main display section 31 (on the side of the player). Game buttons 16 (a BET button, a reels rotating button, a reels stopping button and the like) as various operation means needed for a game to be played, a slot 17 through which a coin as a medium for a game is inserted, and the like are formed on this pedestal portion 15.

Furthermore, a payout port 8 through which coins are paid out depending on a result of a game and a receiver 9 for receiving the paid-out coins are provided below the pedestal portion 15.

An upper portion of this slot machine 1 constitutes a display unit 2 according to an embodiment of the present invention. Specifically, a secondary display section 22 is provided above the main display section 31. The secondary display section 22 is one through which, for example, a second game (what is called a “second game”) is played under a predetermined condition subsequent to a game to be played through the main display section 31. This secondary display section 22 is formed as a liquid crystal display device, and is detachably attached to the cabinet 10 as described later. Speakers 25L and 25R are provided on the both sides of this secondary display section 22. The speakers 25L and 25R are ones which generates effect sounds for the purpose of enhancing the player's interest in the game while the game is being played. In other words, the display unit 2 is constituted of the secondary display section 22, the upper portion of the cabinet 10 as a housing for providing a setting area to which the secondary display section is set, and the speakers 25L and 25R.

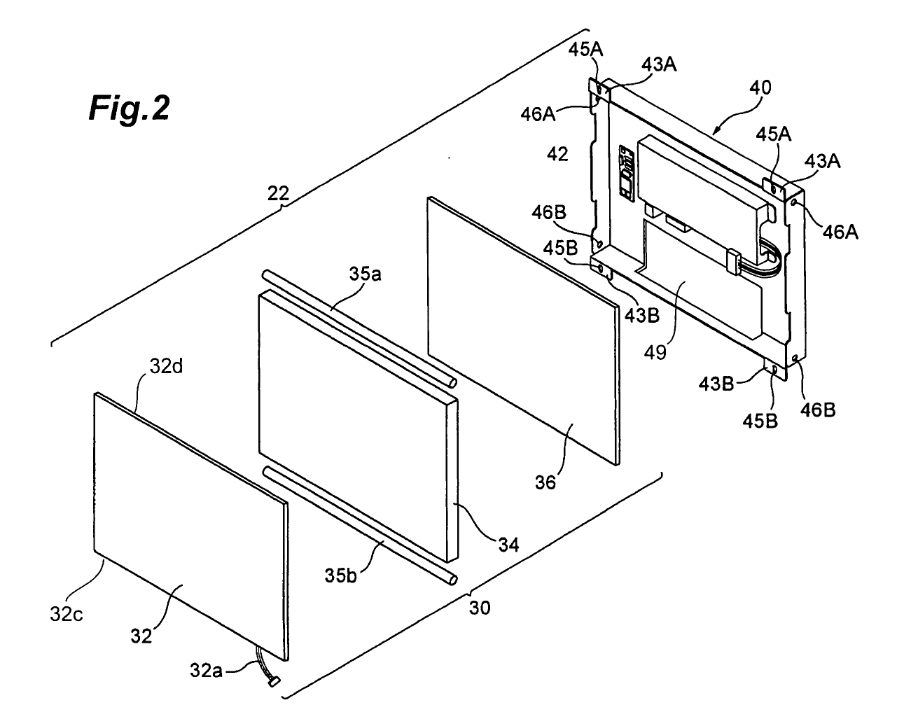

FIG. 2 shows the structure of the secondary display section 22 constituted as the transmissive liquid crystal display device in a state where the structure is broken down. As shown in the figure, the secondary display section 22 is constituted of a liquid crystal panel unit 30 including at least a liquid crystal panel 32 with a predetermined size (approximately 20 inches), a light guiding plate 34 and a reflection plate 36; and a attaching member 40 which is a rectangle-shaped frame, which holds the liquid crystal panel unit 30, and which has an IC drive 42 for driving the liquid crystal panel 32.

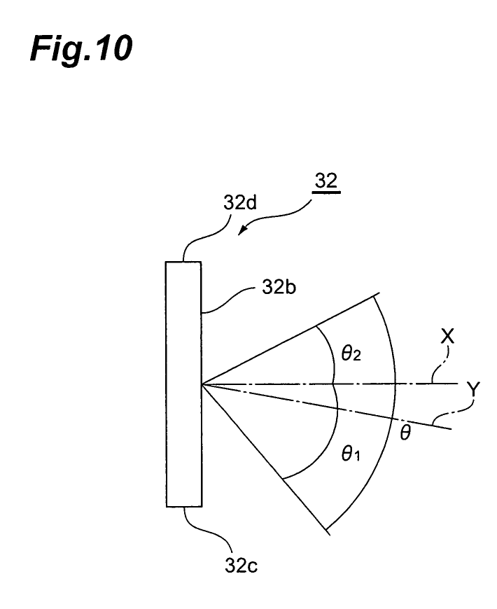

The liquid crystal panel 32 is constituted of a pair of transparent substrates (for example, glass substrates) and liquid crystal material which is interposed and held between the pair of transparent substrates. The liquid crystal panel 32 has different viewing angles on one side and the other side of the panel area (the upper side and the lower side in a case of the present embodiment). That is, a center axis Y of a viewing angle in the liquid crystal panel unit 30 is not parallel to a normal line X of a surface (display surface) 32b of the liquid crystal panel 32. It should be noted that the center axis Y of the viewing angle is generally on a center of the liquid crystal panel 32. In this embodiment, with regard to the liquid crystal panel 32, as shown in FIG. 10, a viewing angle θ is deviated to one side in the direction parallel with the surface (display surface) 32b of the liquid crystal panel 32. Consequently, in a case where the viewing angle θ of the liquid crystal panel 32 is divided into a sub-viewing angle θ₁ on one side and the other sub-viewing angle θ₂ on the other side by defining the normal line X crossing the liquid crystal panel 32, the sub-viewing angle θ₁ is larger than the other sub-viewing angle θ₂. For example, the viewing angle θ of the liquid crystal panel is an angle in which a contrast ratio is kept at 5 or more, the viewing angle θ is 135 degrees, the sub-viewing angle θ₁ is 80 degrees, and the sub-viewing angle θ₂ is 55 degrees. In addition, the liquid crystal panel 32 may be a passive liquid crystal display device or an active matrix liquid crystal display device. Further, a wiring cable 32a to be electrically connected to the IC drive 42 of the attaching member 40 is extends out from the liquid crystal panel 32.

The rectangle-shaped light guiding plate 34 having the same size as the liquid crystal panel 32 does (for example, the light guiding plate 34 is formed of transmissive material such as acrylic resin and the like) is arranged in the back of the liquid crystal panel 32 (on the side opposite to the game player). Furthermore, the reflection plate 36 is arranged in the back of the light guiding plate 34, and the attaching member 40 is arranged in the back of the reflection plate 36.

Additionally, light sources 35a and 35b are arranged along the upper and lower edge surfaces of the light guiding plate 34 respectively. These light sources 35a and 35b are for making a beam of light incident onto the light guiding plate 34. In cooperation with the light guide plate 34, the light sources 35a and 35b constitute a back light for the liquid crystal panel 32 (supply the back light to the liquid crystal panel 32). Cold-cathode tubes and fluorescent lamps may be used as the light sources 35a and 35b. Otherwise, LEDs may be used as the light sources 35a and 35b.

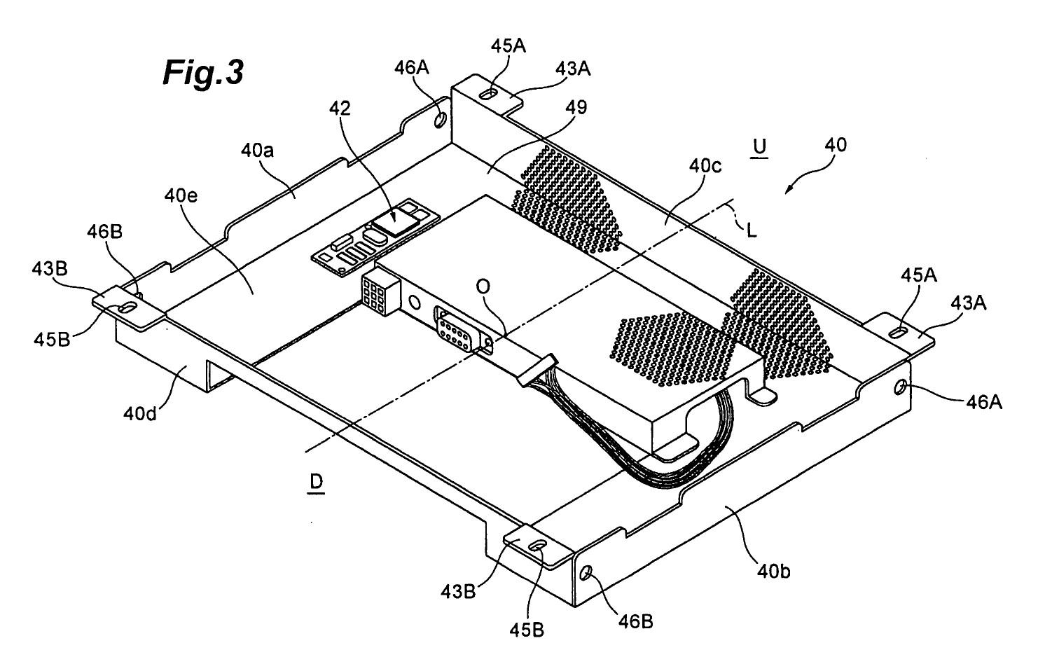

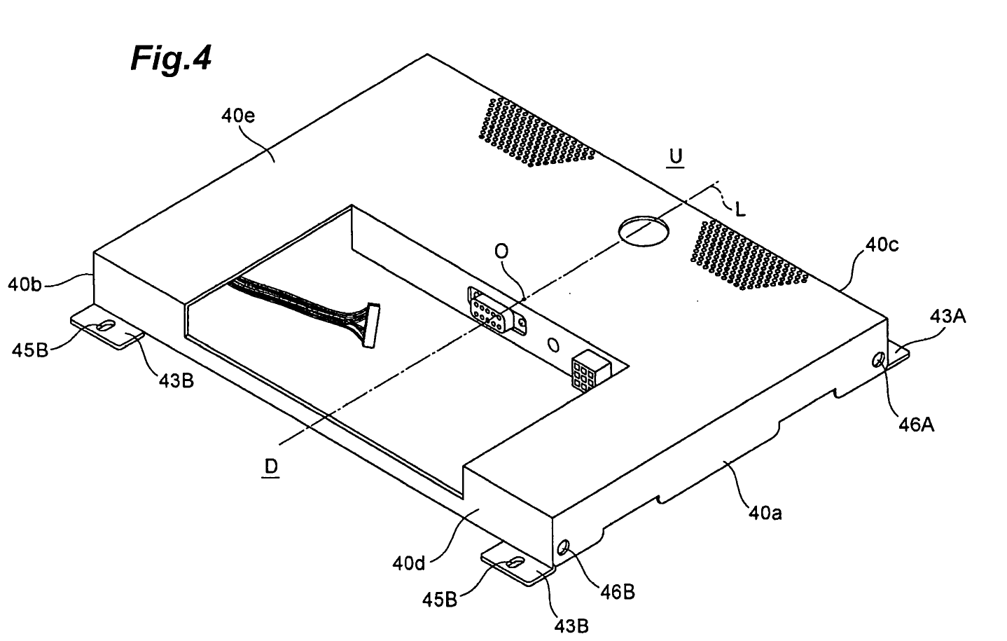

In addition, as shown in FIGS. 3 and 4 on an enlarged scale in detail, the attaching member 40 to be formed as a rectangle-shaped frame, or a supporting member for supporting the liquid crystal panel unit 30, includes: two side surfaces 40a and 40b; an upper surface 40c and a lower surface 40d for connecting these side surfaces 40a and 40b together; and a back surface 40e. The combination of these surfaces constitutes a containing space 49 for containing the liquid crystal panel unit 30. Furthermore, in the interior of the containing space 49, the IC drive 42 for driving the liquid crystal panel 32 is fixed to, and provided on, the back surface 40e.

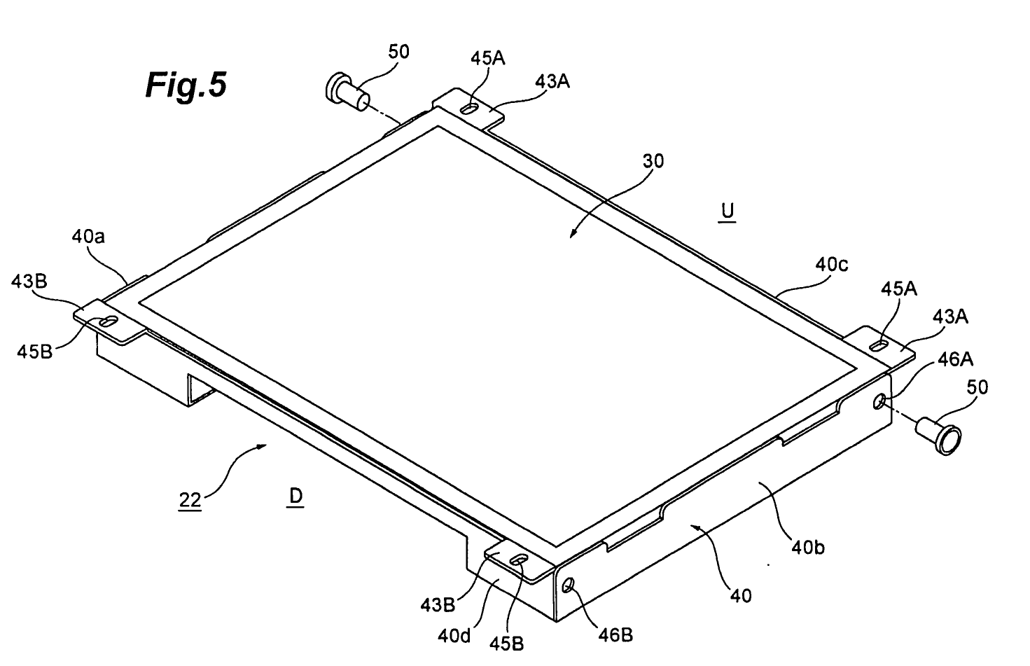

With regard to each of the two side surfaces 40a and 40b of the attaching member 40, an engaging portion which detachably engages with the cabinet 10 or a suspendable portion which is suspended from an upper portion of the cabinet 10, and a fixable portion which is fixed to the cabinet 10 are provided on each of the lower side D and the upper side U corresponding respectively to one side and the other side of the liquid crystal panel 32 of which viewing angle is different between one side and the other side. Specially, the engaging portions (suspendable portions) include upper shaft holes 46A which are formed on the upper sides U respectively of the two side surfaces 40a and 40b of the attaching member 40, and lower shaft holes 46B which are formed on the lower sides D respectively of the two side surfaces 40a and 40b of the attaching member 40. In addition, shafts 50 (see FIG. 5 and the like) constituting the engaging portion (suspendable portion) in cooperation with the shaft holes 46A and 46B are detachably attached into these shaft holes 46A and 46B in a selective manner. On the other hand, the fixable portions include upper brackets 43A which are formed on both sides of the upper surface 40c of the attaching member 40, and lower brackets 43B which are formed on both sides of the lower surface 40d of the attaching member 40. Additionally, screw insertion holes 45A and 45B through which bodies of respective fastening screws 64 (described later) for fixing the attaching member 40 to the cabinet 10 pass, are formed in the respective brackets 43A and 43B. In this manner, with regard to the attaching member 40 of the present embodiment, a pair constituted of the shaft hole 46A and the bracket 43A is provided on each of the two sides on the upper side U thereof, and a pair constituted of the shaft hole 46B and the bracket 43B is provided on each of the two sides on the lower side D thereof. The attaching member 40 has a shape substantially symmetrical around the central line L which passes the center O of the attaching member 40, and which is parallel with the side surfaces 40a and 40b.

Next, a description will be provided for a case where the liquid crystal panel unit 30 with the aforementioned configuration is attached to the upright-type slot machine 1 through the attaching member 40.

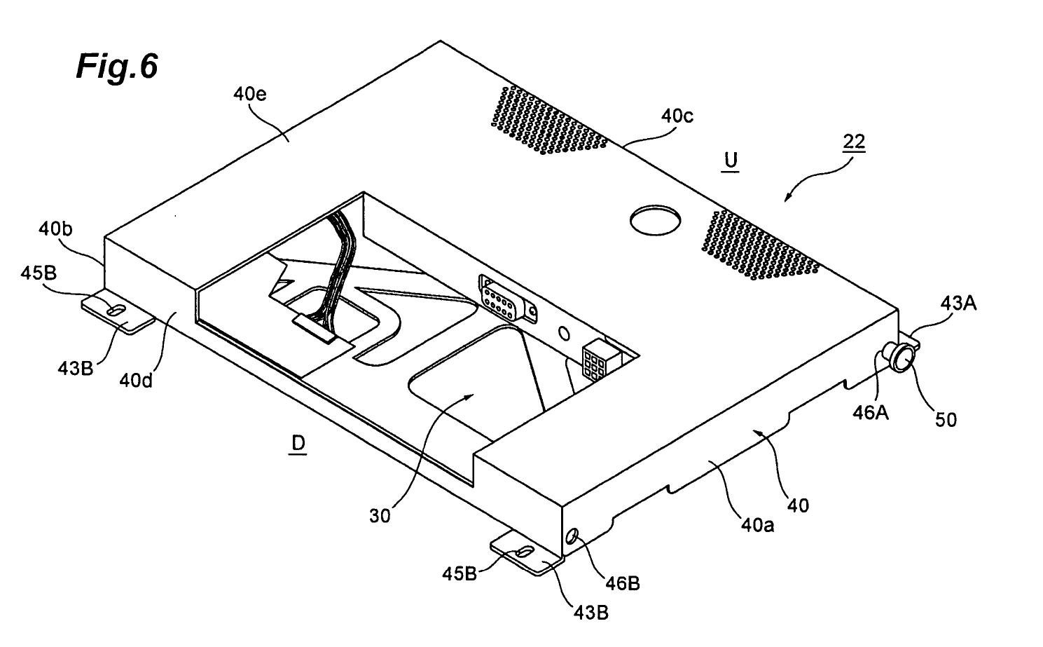

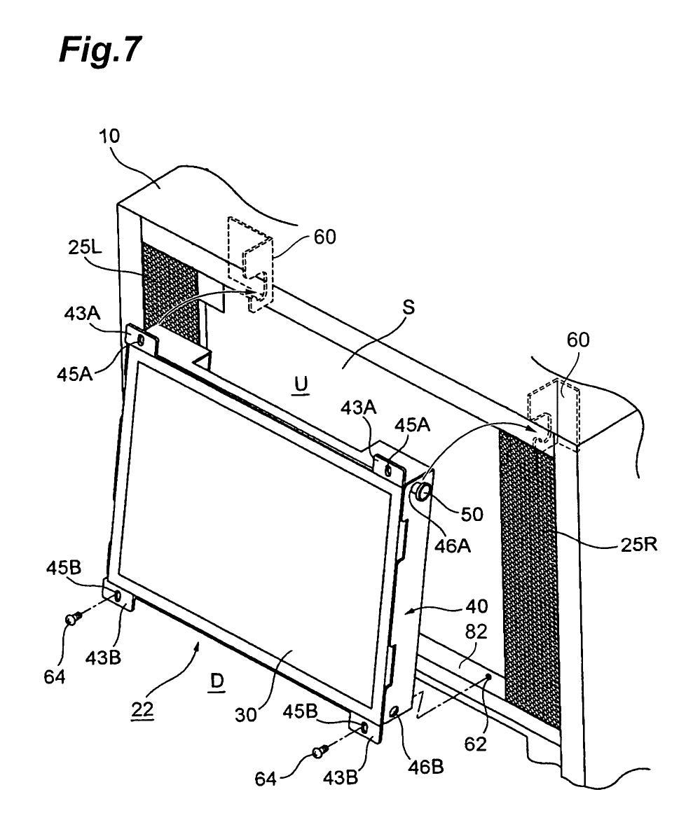

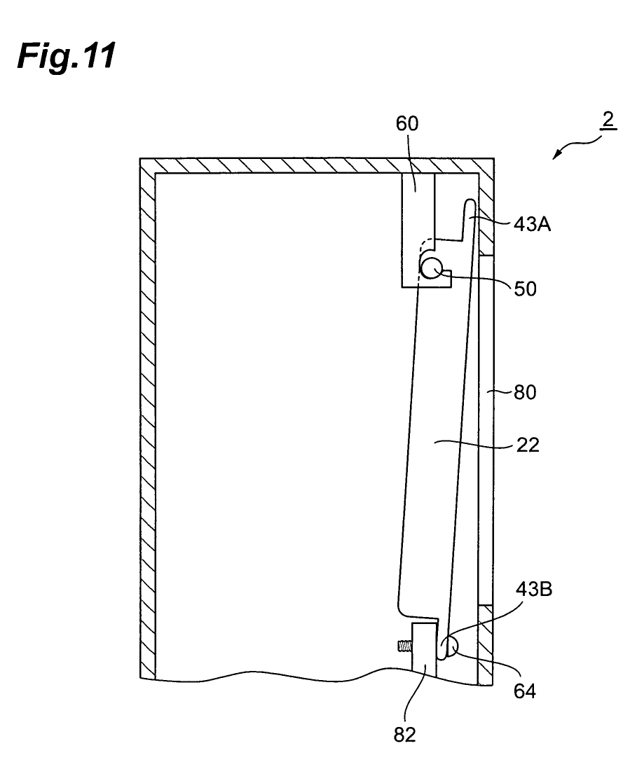

First of all, as shown in FIGS. 5, 6 and 11, a wiring cable 32a of the liquid crystal panel 32 is electrically connected to the IC drive 42 of the attaching member 40, and the liquid crystal panel unit 30 is contained in, and jointed to, the containing space 49 of the attaching member 40 (see FIG. 3). In addition, in order to make the specification for the viewing angle of the liquid crystal panel 34 agree with the upright-type slot machine 1, for example, the shafts 50 is fitted to each of the pair of shaft holes 46A and 46A on the upper side U. Subsequently, as shown in FIG. 7, while this state is maintained, the pair of shafts 50 and 50 provided on the upper side U of the attaching member 40 are hooked up on corresponding hook-shaped hook portions 60 (i.e. hooks 60 as the fixing portions) provided on the upper side of the setting area S for the secondary display section 22 in the upper portions of the cabinet 10, or the housing, thereby suspending the attaching member 40 (the secondary display section 22) from the cabinet 10. Thereafter, the screw insertion holes 45B and 45B of the pair of brackets 43B and 43B provided on the lower side D of the attaching member 40 are caused to match screw holes 62 and 62 correspondingly provided on the side of the cabinet 10. Maintaining this state, fastening screws 64 are screwed up with these holes 62 and 45B, thereby fixing the attaching member 40 (the secondary display section 22) to the cabinet 10. In other words, the fastening screws 64 and the screw holes 62 provided in projecting pieces 82 of the cabinet 10 (housing) constitute the fixing portions for fixing the secondary display section (liquid crystal display device) 22. Accordingly, the brackets 43B, which are the fixable portions, are interposed and held between the projecting pieces 82 and the fastening screws 64, thus fixing the secondary display section 22 to the cabinet 10. In addition, as shown in FIG. 11, in front of the secondary display section 22, a transparent protecting plate 80 for protecting the liquid crystal panel 32 is attached to the cabinet. Further, in a state where the secondary display section 22 is contained in the cabinet 10, the brackets 43A and 43B are covered with the cabinet 10, and only the surface (display surface) of the liquid crystal panel 32 is designed to be viewed through the protecting plate 80.

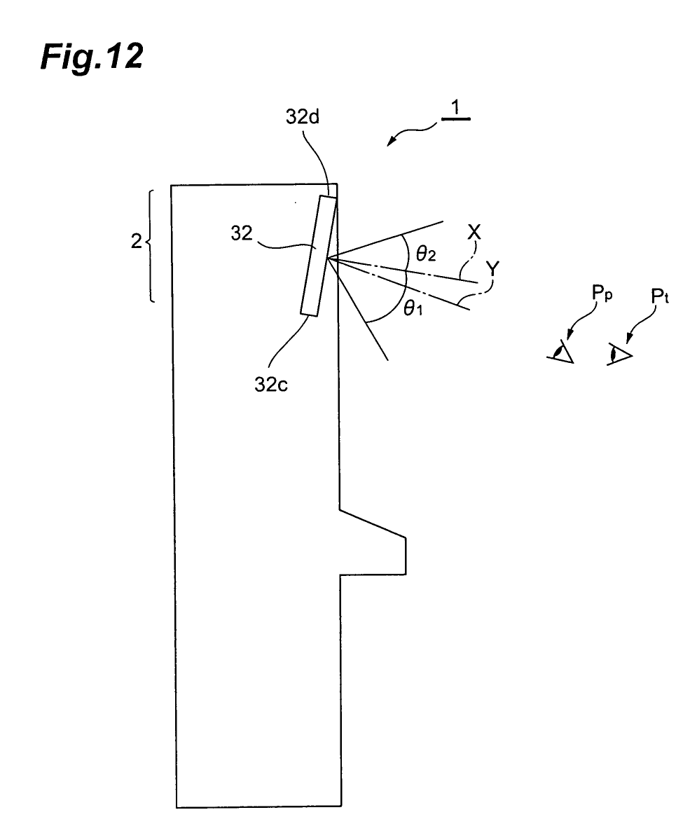

Here, in the upright-type slot machine 1, as shown in FIG. 12, the viewpoint Pₚ of the player who looks into the liquid crystal panel 32 in front of the slot machine 1 and the viewpoint Pₜ of an audience who looks into the liquid crystal panel 32 from the back of the player are positioned on the lower side with respect to the normal line X. Consequently, in the upright-type slot machine 1, the liquid crystal panel 32 is mounted in a way that an edge 32c on one side of the liquid crystal panel 32 is positioned lower than an edge 32d on the other side of the liquid crystal panel 32. By this, the upright-type slot machine 1 can be able to provide a wider viewing angle to the player and the audience.

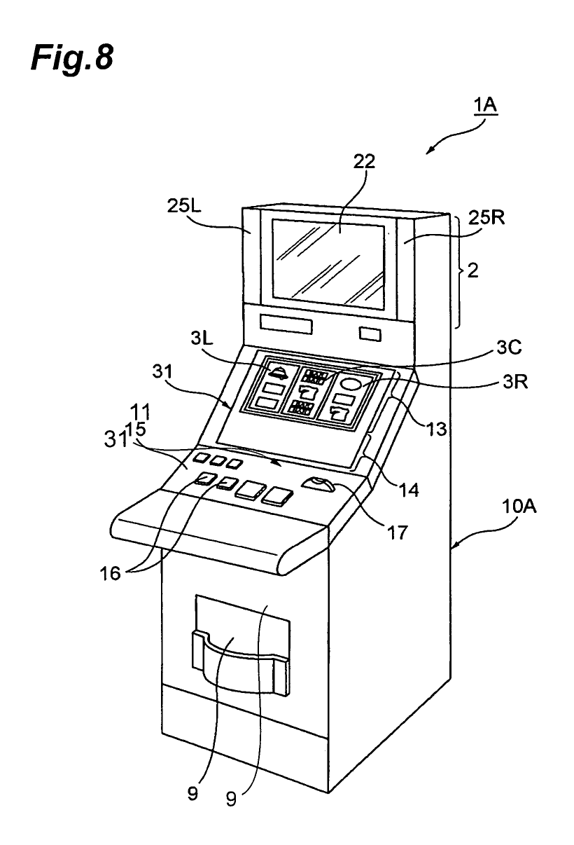

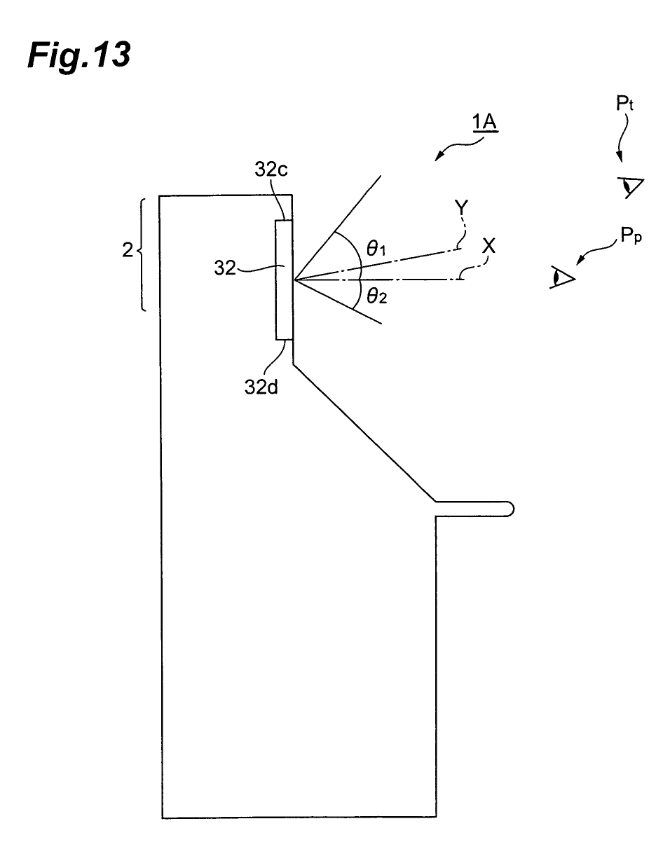

On the other hand, when, by changing the direction of the secondary display section 22 from this state, the secondary display section 22 is used for a slant-type slot machine 1A (see FIG. 8; the same reference numerals are assigned to constituent parts of FIG. 8 corresponding to those of FIG. 1.) for which a viewpoint of the player is reversed from a viewpoint of the player for the upright-type slot machine 1, the secondary display section 22 is attached to the slant-type slot machine 1A in the following manner. The whole of the secondary display section 22 is inverted, as it is, by 180 degrees around the center O, thereby putting the upper viewing angle of the liquid crystal panel 32 downward and the lower viewing angle thereof upward. The shafts 50 are removed from the pair of shaft holes 46A and 46A on the upper side U, and are fitted to the pair of shaft holes 46B and 46B on the lower side D. Thereby, these shafts 50 and 50 are hooked up on the corresponding hook-shaped hook portions provided on the upper side of the setting area S of the secondary display section 22 in the cabinet 10A of the slant-type slot machine 1A, or the hooks 60 as the suspending portions. Thereby, the attaching member 40 (secondary display section 22) is suspended from the cabinet 10A in a way that the lower side D thereof is upward. Thereafter, the screw insertion holes 45A and 45A respectively of the pair of brackets 43A and 43A provided on the upper side U of the attaching member 40 are caused to agree with the screw holes correspondingly provided on the side of the cabinet 10A. Then, while this state is maintained, the fastening screws 64 are screwed up with these holes, thereby fixing the attaching member 40 (secondary display section 22) to the cabinet 10A. In other words, in the slant-type slot machine 1A, as shown in FIG. 13, the viewpoint Pₚ of the player who looks into the liquid crystal panel 32 in front of the slot machine 1A and the viewpoint Pt of a audience who looks into the liquid crystal panel 32 from the back of the player are positioned on the upper side with respect to the normal line X. Consequently, in the slant-type slot machine 1A, the liquid crystal panel 32 is mounted in a way that the edge 32c on one side of the liquid crystal panel 32 is positioned higher than the edge 32d on the other side thereof. By this, the slant-type slot machine 1A can be able to provide a wider viewing angle to the player and the audience.

As described above, according to the present embodiment, the secondary display section 22 of the slot machine 1 is configured of the liquid crystal panel unit 30 and the attaching member 40. In addition, the attaching member 40 through which the liquid crystal panel unit 30 is fitted to the cabinet 10, is provided with shaft holes 46A and 46B as the engaging portions (i.e. suspendable portions) which detachably engages with the cabinet 10, and fixable portions 43A, and 43B, on the upper side U and the lower side D, respectively. Note that, when the shafts 50 are fitted into the shaft holes 46A or 46B, these shafts 50 are included in the engaging portions.

Accordingly, both in a first state (a state shown by FIG. 1) that the attaching member 40 is attached to the cabinet 10 and in a second state (a state shown in FIG. 8) that the attaching member 40 is inverted around the center of the attaching member 40 by 180 degrees from the first state, the positions of the respective engaging portions on either side of the attaching member 40 (constituted of the shaft holes 46A or the shaft holes 46B as well as the shafts 50), or the suspendable portions, match the positions of the respective hook portions (engageable portions) 60 on the side of the cabinet 10, or the suspending portions. In addition, the positions of the respective fixable portions on the side opposite to the engaging portions (constituted of the brackets 43B and the screw insertion holes 45B, or constituted of the brackets 43A and the screw insertion holes 45A) match the positions of the screw holes (fixing portions) 62 on the side of the cabinet 10. For this reason, even if the whole of the secondary display section 22 is inverted by 180 degrees in order to use the liquid crystal panel unit 30 for both the slant-type slot machine and the upright-type slot machine, between which viewpoint of the player is different on the upper and lower sides thereof, the secondary display section 22 can be attached to the cabinet 10 of the slot machine. In other words, the attaching member 40 can be used for both the slant-type slot machine and the upright-type slot machine. As a result, the whole of the liquid crystal display device configured of the attaching member 40 and the liquid crystal panel unit 30 can be used for both the slant-typed slot machine and the upright-type slot machine. For this reason, relevant costs can be reduced to a large extent in comparison with a case where some of the fitting bodies 40 are used exclusively for the slant-type slot machine and the other of the fitting bodies 40 are used exclusively for the upright-type slot machine.

It should be noted that, in the aforementioned embodiment, the shafts 50 may be fitted in advance into all of the four shaft holes 45A, 45B, 46A and 46B. Otherwise, the shafts may be unable to be removed from the shaft holes 45A, 45B, 46A and 46B.

According to the gaming machine of the present invention, all parts of a liquid crystal display device including a liquid crystal panel having different viewing angles on one side and on the other side can be shared between different types of machines having different player's viewpoint positions on the liquid crystal screen which are on one side or on the other side (for example, the upper side and the lower side). Consequently, reduction in relevant costs can be realized.

In other words, according to the present invention, provided are a display unit capable of being shared between gaming machines having different viewpoint positions of the player and audience, and a gaming machine including the display unit. Consequently, according to the present invention, reduction in costs for the gaming machine can be achieved.

It should be noted that the present invention can be adapted to various gaming machines such as a pachinko machine and the like in addition to being adapted to the slot machine as described in the aforementioned embodiment. The present invention is effective in a case where all of the parts of the liquid crystal display device comprising the liquid crystal panel whose viewing angle is different between one side and the other side thereof, or the liquid crystal panel whose viewing angle is deviated to one side, are used for both of the different types of gaming machines, between which a viewpoint of the player on the liquid crystal screen is different on one side and the other side.

1. A display unit comprising:
a liquid crystal display device having a liquid crystal panel unit including a liquid crystal panel and a supporting member for supporting the liquid crystal panel unit; and
a housing for providing a setting area to which the liquid crystal display device is set,
wherein a center axis of a viewing angle in the liquid crystal panel unit is not parallel to a normal line of a surface of the liquid crystal panel,
the housing has a suspending portion from which the liquid crystal display device is suspended and a fixing portion which is provided below the suspending portion, and which fixes the liquid crystal display device to the housing, and
the supporting member has a suspendable portion which is hooked up on the suspending portion and a fixable portion which is fixed to the fixing portion on one side and the other side with respect to a center of the supporting member in the direction respectively.

2. The display unit according to claim 1,
wherein the supporting member is a rectangle-shaped frame,
the suspending portion is a hook,
the fixing portion includes a fastening screw, and a screw hole to which the fastening screw is screwed up,
the suspendable portion includes shaft holes which are formed respectively on the one side and the other side in a side surface of the frame and shafts which are detachably fitted into the shaft holes respectively, and
the fixable portion is a bracket including a hole through which a body of the fastening screw is passed.

3. The display unit according to claim 1, wherein the suspendable portion and the fixable portion are provided on each of the one side and the other side in a manner symmetrical around the center.

4. A gaming machine comprising the display unit according to claim 1.

5. A gaming machine comprising:
a cabinet in which an apparatus needed for a game is contained;
a liquid crystal panel unit having a liquid crystal panel for displaying an image associated with the game, the liquid crystal panel having different viewing angles on one side and on the other side on a display screen thereof; and
an attaching member which has a driver for driving the liquid crystal panel, and through which the liquid crystal panel unit is attached to the cabinet,
wherein the attaching member has engaging means which detachably engages with the cabinet and fixable means which is fixed to the cabinet on both of the one side and the other side thereof.

6. The gaming machine according to claim 5,
wherein the attaching member is a rectangle-shaped frame,
the engaging means is formed on a side surface of the frame, and has a shaft hole into which a shaft to be hooked up on the cabinet is detachably fitted,
the fixable means has a bracket which is formed in the frame and a screw insertion hole which is formed in the bracket, and which a screw for fixing the frame to the cabinet passes through, and
a pair of the shaft hole and the bracket is provided on the one side and the other side respectively.

7. The gaming machine according to claim 5, wherein the attaching member has a shape substantially symmetrical around a central line passing the center thereof.
